(19) United States
(12) Patent Application Publication
(10) Pub. No.: US 2004/0125617 A1
(43) Pub. Date: Jul. 1, 2004

(54) Programmable photo-coupler-isolated wide band modulator for high voltage power supply

(75) Inventors: Jang-Tzeng Lin, Hsinchu City (TW); Ching-Fu Hsieh, Taoyuan County (TW); Chih-Wei Ho, Taoyuan County (TW); Yuh-Ren Hsieh, Hsinchu County (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/664,976

(22) Filed: Sep. 22, 2003

(30) Foreign Application Priority Data
Dec. 30, 2002 (TW) 91137895

(51) Int. Cl. H02M 3/335

(52) U.S. Cl. 363/16

(57) ABSTRACT

A programmable photo-coupler-isolated wide band modulator for high voltage power supply is disclosed, which utilizes a high voltage module to step up the input voltage and utilizes a wide band modulator connected with the high voltage module to modulate the high voltage output from the high voltage module for outputting a wide band high voltage, wherein the wide band modulator receives a modulator signal generated by a computer for modulating.

### BACKGROUND OF THE INVENTION

1. Field of the Invention

The present invention relates to power supplies and, more particularly, to a programmable photo-coupler-isolated wide band modulator for high voltage power supply which can be applied to many fields, such as capillary electrophoresis power or hybrid electric field power in biomedical field, photomltiplier tubes or avalanche photodiodes in electro-optical field, solid state detectors or ion pumps in electric field.

2. Description of Related Art

A conventional power supply can only supply fixed voltage or current and does not have a modulation capability. There are a number of commercially available waveform generators capable of generating waveforms. However, an output voltage of the waveform generator is typically limited to be less than or equal to 15 V. Further, some available high voltage modulators can only output fixed voltage or have a small modulation capability, i.e., have narrow modulation bandwidth or no wide band modulation capability.

Currently, high voltage (e.g., up to several tens KV) and wide band modulation are required in many applications such as radar sets, X-ray devices, semiconductor machines, etc. However, the prior art power supply, as stated above, does not have the desired capability.

Therefore, it is desirable to provide a novel power supply capable of supplying high voltage and having a wide band modulation capability in order to mitigate and/or obviate the aforementioned problems.

### SUMMARY OF THE INVENTION

An object of the present invention is to provide a programmable photo-coupler-isolated wide band modulator for high voltage power supply. The power supply has the advantages of programmable control, wide band modulation and continuous adjustment.

To achieve the object, the present invention provides a programmable power supply comprising a low voltage power supply unit providing at least one low voltage; an frequency converter unit for receiving the low voltage and converting it into a high frequency low AC voltage; a high voltage module for receiving the AC voltage and increasing the AC voltage; and a wide band modulation module coupled to the high voltage module for converting the AC voltage into a DC voltage and receiving an external modulated signal, the modulated signal being activated to switch the DC voltage for generating and outputting a wide band modulated DC voltage.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of a wide band modulator for high voltage power supply according to the invention;

FIGS. 2a and 2b are circuit diagrams of transformer isolator, optical coupler isolator and high voltage switch assembly showing single and double polarity outputs respectively; and

FIGS. 3a, 3b, 3c and 3d are waveforms showing 30 KV of DC (direct current) output, modulated 30 KV, modulated −5 KV, and modulated 5 KV and −5 KV respectively.

### DETAILED DESCRIPTION OF THE PREFERRED EMBODIMENT

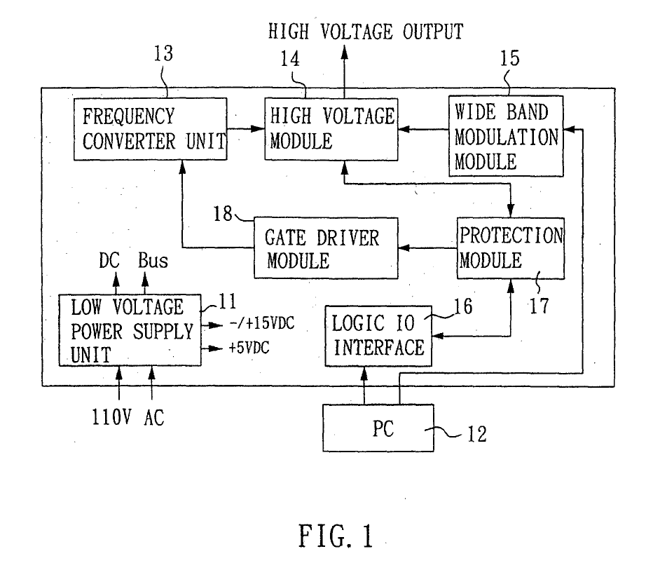

With reference to FIG. 1, there is shown a modulation device for high voltage power supply in accordance with the invention comprising a low voltage power supply unit 11, an frequency converter unit 13, a high voltage module 14 including a high voltage switch assembly 141, a wide band modulation module 15 including a transformer isolator circuit 151 and an photo-coupler-isolated circuit 152 including a plurality of optical couplers 1521, a logic IO (input/output) interface 16, a protection module 17, and a gate driver module 18. Each component is described in detail below.

An input voltage of the low voltage power supply unit 11 is 110 V AC (alternating current). A plurality of outputs of low DC voltage are generated by the low voltage power supply unit 11. For example, 5 V DC or 15 V DC are two exemplary voltage outputs for normal operation of other components. The frequency converter unit 13 receives one voltage output from the low voltage power supply unit 11 and converts it into a high frequency low AC voltage which is in turn sent to the high voltage module 14 for increasing voltage. The protection module 17 is coupled to the high voltage module 14, the logic IO interface 16, and the gate driver module 18 respectively. As such, a PC (personal computer) 12 can control the protection module 17 via the logic IO interface 16 and control the high voltage module 14, the gate driver module 18, and the frequency converter unit 13 via the protection module 17 for protection against over current, over voltage, etc.

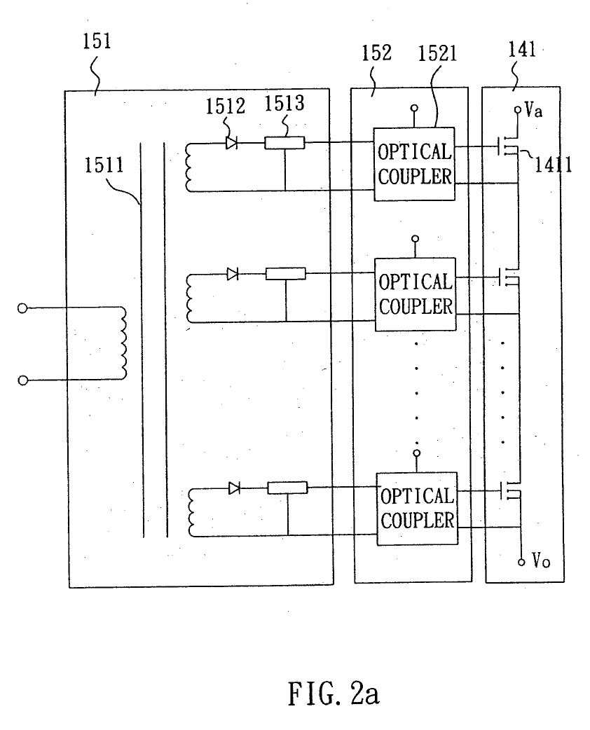

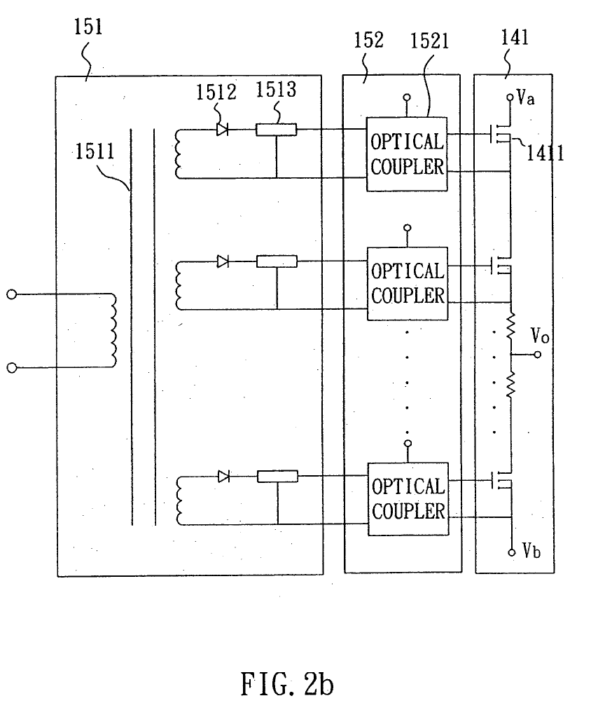

The high voltage module 14 increases the high frequency low AC voltage by its internal booster circuit and rectifier circuit for supplying a constant high voltage such as several tens KV or preferably 50 KV. The high voltage is then fed to the high voltage switch assembly 141. With reference to FIG. 2a, operations of the transformer isolator circuit 151, the photo-coupler-isolated circuit 152, and the high voltage switch assembly 141 are illustrated in which a single polarity output is obtained. In detail, the transformer isolator circuit 151 can isolate low voltage input side from high voltage output side and store electrical energy. In the embodiment, the low voltage input is a low AC voltage which is supplied by a small power supply (not shown) or the low voltage power supply unit 11. The low AC voltage is fed to a primary coil of a transformer 1511. Next, a plurality of voltage outputs are generated at a secondary coil of the transformer 1511. The voltage outputs are then rectified and regulated by respective pairs of diode 1512 and voltage regulator 1513 sequentially for generating a constant voltage which is fed to the corresponding optical coupler 1521 of the photo-coupler-isolated circuit 152. The photo-coupler-isolated circuit 152 is interconnected between the transformer isolator circuit 151 and the high voltage switch assembly 141 for switching (i.e., controlling) the on/off of each high voltage switch 1411 of the high voltage switch assembly 141 and providing a feedback compensation to the modulate device. Each optical coupler 1521 receives a modulated signal from the PC 12. The modulated signal is switched to provide a wide band modulated DC voltage (e.g., at about 100 KHz) and have a high bandwidth to period ratio. The high voltage switch 1411 is implemented as a transistor capable of permitting a voltage input of several hundred volts such as 800V in the embodiment. High voltage input of the high voltage switch assembly 141 is Va. A continuous modulated high voltage from about 0V to about 30 KV is outputted at Vo. With reference to FIG. 2b, there is shown a modification of the FIG. 2a circuit. In detail, the circuitry of the high voltage switch assembly 141 is changed in which Va and Vb are positive and negative high voltage inputs respectively and Vo is double polarity high voltage output (e.g., 15 KV or −15 KV). The PC 12 can effect a programmable control on the modulated voltage waveforms for generating high or low voltage waveforms and display voltage outputs. Also, the PC 12 can replace a programmable single chip or a signal generator capable of modulating signal waveforms.

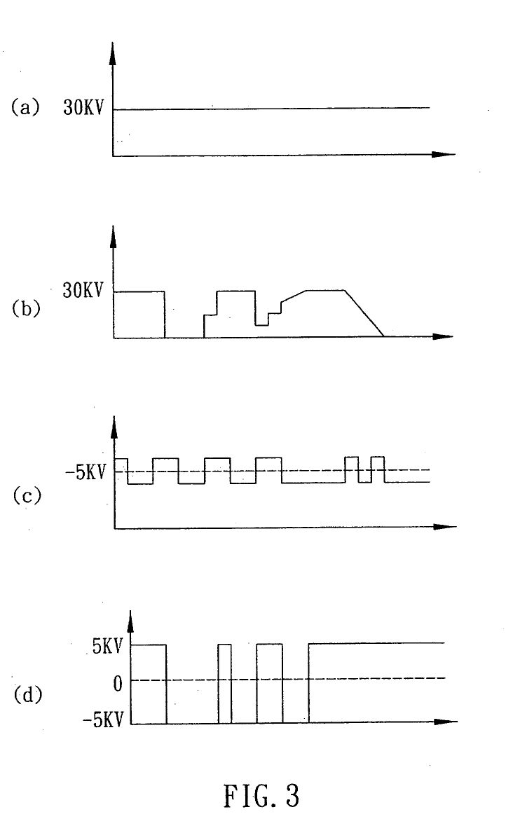

With reference to FIGS. 3a, 3b, 3c, and 3d there are shown waveforms of 30K VDC output, modulated 30K VDC modulated by the PC 12, modulated −5 KV, and modulated 5 KV and −5 KV respectively.

Although the present invention has been explained in relation to its preferred embodiment, it is to be understood that many other possible modifications and variations can be made without departing from the spirit and scope of the invention as hereinafter claimed.

What is claimed is:

1. A programmable photo-coupler-isolated wide band modulator for high voltage power supply, comprising:
a low voltage power supply unit providing at least one low voltage;
an frequency converter unit for receiving the low voltage and converting it into a high frequency low AC voltage;
a high voltage module for receiving the AC voltage and increasing the AC voltage; and
a wide band modulation module coupled to the high voltage module for converting the AC voltage into a DC voltage and receiving an external modulated signal, the modulated signal being activated to switch the DC voltage for generating and outputting a wide band modulated DC voltage.

2. The power supply as claimed in claim 1, wherein the high voltage module comprises a high voltage switch assembly for outputting either a single or a double polarity output.

3. The power supply as claimed in claim 2, wherein the high voltage switch assembly comprises a plurality of high voltage switches.

4. The power supply as claimed in claim 3, wherein the high voltage switch is a transistor.

5. The power supply as claimed in claim 1, wherein the wide band modulation module comprises a transformer isolator circuit and a photo-coupler-isolated circuit coupled to the transformer isolator and the high voltage switch assembly respectively.

6. The power supply as claimed in claim 5, wherein the photo-coupler-isolated circuit is capable of receiving the modulated signal and switching each of the high voltage switches as enabled by the modulated signal.

7. The power supply as claimed in claim 1, wherein the wide band modulation module comprises a transformer isolator circuit for isolating a low voltage input side from a high voltage output side and a photo-coupler-isolated circuit.

8. The power supply as claimed in claim 7, wherein the photo-coupler-isolated circuit comprises a plurality of optical couplers for receiving the modulated signal.

9. The power supply as claimed in claim 1, further comprising a computer for generating a modulated signal and displaying the same.

10. The power supply as claimed in claim 1, wherein the high voltage module increases the AC voltage for supplying a voltage from 0V to 50 KV.

11. The power supply as claimed in claim 1, wherein the wide band modulated DC voltage is obtained at a frequency about 100 KHz.
